(19) United States
(12) Patent Application Publication
(10) Pub. No.: US 2014/0001203 A1
(43) Pub. Date: Jan. 2, 2014

(54) ON-TAP ADVERTISING HOLDER AND DISPLAY

(71) Applicants: Ryan Goldstein, Bayside, NY (US); Salvo Stock, NY, NY (US)

(72) Inventors: Ryan Goldstein, Bayside, NY (US); Salvo Stock, NY, NY (US)

(21) Appl. No.: 13/931,016

(22) Filed: Jun. 28, 2013

Related U.S. Application Data
(60) Provisional application No. 61/666,642, filed on Jun. 29, 2012.

(51) Int. Cl. G09F 7/18; B67D 1/08

(52) U.S. Cl. CPC G09F 7/18; B67D 1/0877
USPC 222/23; 40/606.03; 40/606.01

(57) ABSTRACT

An advertising holder and display for use with a beverage dispenser, such a beverage tap, includes an attachment mechanism configured to mate with the beverage dispenser. The advertising holder and display also includes an elongate connector with a first end and a second end, with the first end of the connector being connected to the attachment mechanism. An advertisement frame that is adapted to hold an advertisement is connected to the second end of the connector.

### CROSS-REFERENCE TO RELATED APPLICATIONS

This application claims priority to U.S. Provisional Patent Application No. 61/666,642, filed Jun. 29, 2012. The contents of that application are incorporated by reference herein in their entirety.

### BACKGROUND OF THE INVENTION

1. Field of the Invention

Generally speaking, the invention relates to advertising holder and display structures, and more particularly, to an on-tap advertising holder and display.

2. Description of Related Art

Beer, wine, and sprits are very widely enjoyed both in the United States and throughout the world. They are also heavily regulated, with laws regarding minimum drinking ages; how, when, where, and by whom beer, wine, and spirits can be sold; and how these products can be marketed.

Alcoholic beverages have some of the strongest brand identification and consumer loyalty of any products on the market. However, marketing them to the public can be particularly difficult, both because of the extensive industry regulation and because of public perceptions about alcohol. One particular issue is that some jurisdictions ban explicit co-advertising of beer and some types of distilled liquors, even though these beverages are often enjoyed in combination. For example, in those jurisdictions, it would be illegal or impermissible to advertise a beer brand and a liquor brand in the same printed advertisement.

Even when it is permissible to advertise a product, or to advertise two products together, conventional printed advertisements on billboards and in magazines, newspapers, and online tend to influence long-term brand loyalties and buying patterns, but may not be as effective at influencing in-the-moment purchases at the point of sale.

### SUMMARY OF THE INVENTION

One aspect of the invention provides an on-tap advertising holder and display. The on-tap advertising holder and display comprises an attachment portion, a connector, and an advertisement frame. The connector extends between and connects the attachment portion and the advertisement frame. In one embodiment of the invention, the attachment portion may be a circular clamp sized and adapted to attach to a beer tap, and the advertisement frame may hold a printed advertisement on a medium such as card stock. In some embodiments, the connector may be essentially rigid; in other embodiments, it may be flexible, so as to position the advertisement frame in various positions. In yet other embodiments, the advertisement frame may include integral lighting elements and a power supply to power those elements.

Another aspect of the invention relates to a beverage dispenser with an advertisement holder. The beverage dispensers include at least a faucet structure and a faucet handle. The advertisement holder comprises a clamp, an advertisement frame, and a flexible, positionable shaft. The clamp is sized, shaped, and adapted to attach to the faucet structure. The advertisement frame is adapted to hold an advertisement. The shaft is connected between the clamp and the advertisement frame and has sufficient rigidity to hold the advertisement frame in a defined position.

Yet another aspect of the invention relates to a method for advertising a product. The method comprises installing an on-tap advertising holder and display on a beverage tap. The advertising holder and display comprises an attachment portion, a connector, and an advertisement frame. The connector extends between and connects the attachment portion and the advertisement frame, and installing a relevant advertisement in the advertisement frame. In some embodiments, the method may further comprise connecting a portion of the advertising holder and display to the beverage tap, such that actuation of the beverage tap causes the advertising holder and display to move or vibrate.

Other aspects, features, and advantages of the invention will be set forth in the description that follows.

### BRIEF DESCRIPTION OF THE DRAWING FIGURES

The invention will be described with respect to the following drawing figures, in which:

FIG. 1 is a perspective view illustrating the installation of one embodiment of the on-tap advertising holder and display installed on the faucet coupling nut of a beverage tap;

FIGS. 2 and 3 are perspective views of the installation clamp of the advertising holder and display of FIG. 1 in open and closed positions, respectively;

FIG. 4 is a perspective view of an advertising holder and display that includes a flexible connector, in accordance with another embodiment of the invention;

FIG. 5 is a perspective view of an advertising holder and display that includes a resilient connector and a coupling that connects it to the handle of a beverage tap, in accordance with yet another embodiment of the invention; and

FIG. 6 is a perspective view of another further embodiment of an advertising holder and display that includes lighting around the advertisement holder.

### DETAILED DESCRIPTION

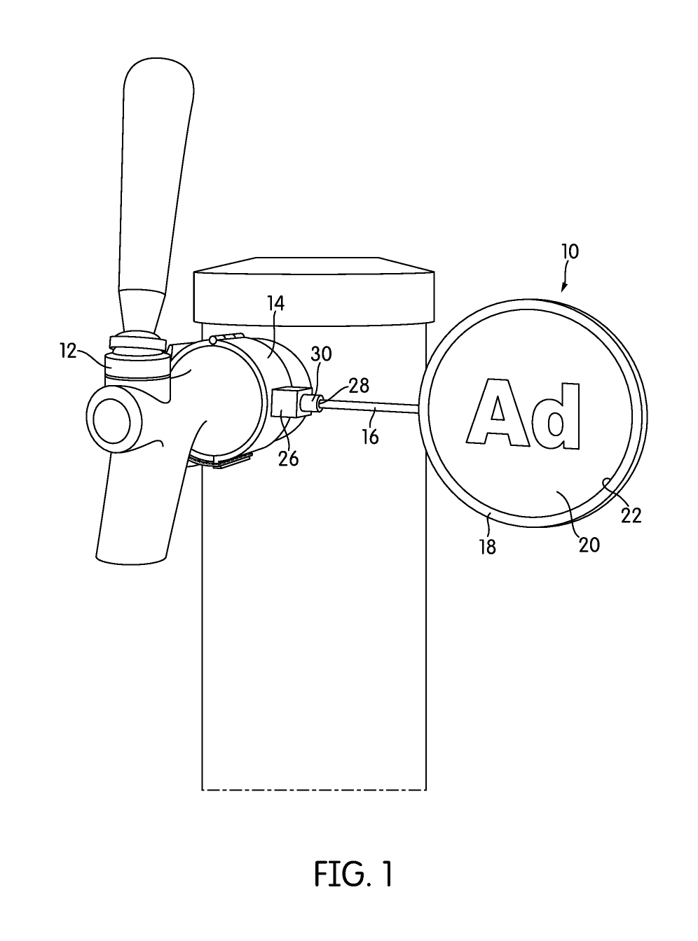

FIG. 1 is a perspective view of an advertising holder and display, generally indicated at 10, according to one embodiment of the invention, shown as installed on the faucet coupling nut or hardware of a beverage tap 12. The beverage tap 12 may, for example, be a beer tap. Although certain elements of the advertising holder and display 10 will be described below with respect to a beer tap 12, it should be understood that the advertising holder and display 10 may be installed in other locations and on other devices.

As shown in FIG. 1, the advertising holder and display 10 comprises three main elements: an attachment portion 14, a connector 16, and an advertisement frame 18. The advertisement frame 18 is adapted to hold an advertisement 20, which, in the illustrated embodiment, is in the form of a round card.

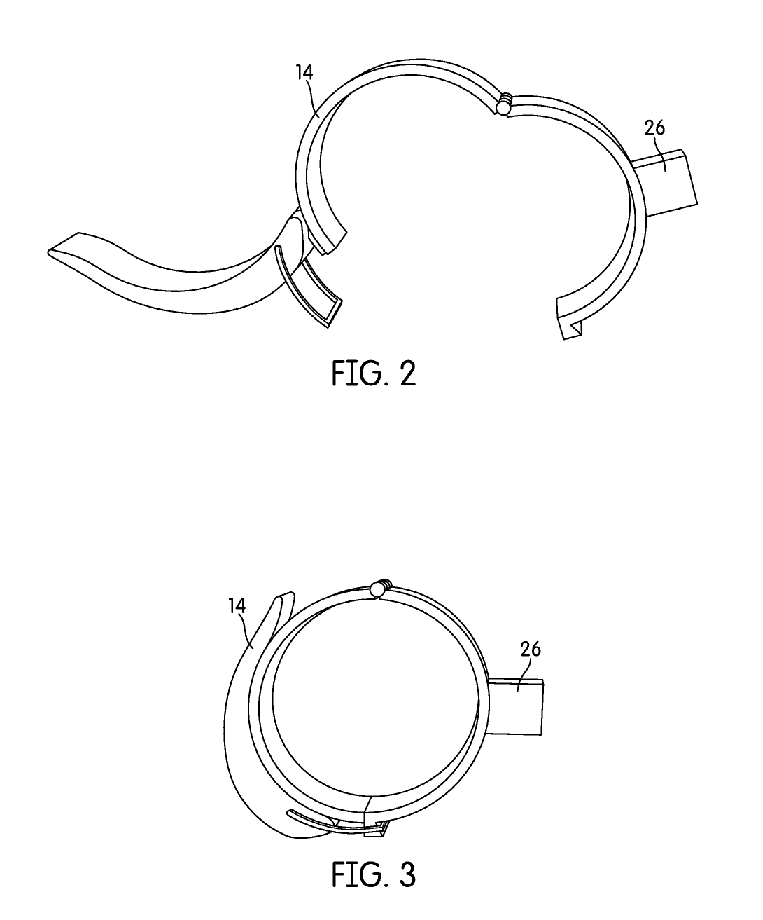

FIGS. 2 and 3 are perspective views of the attachment portion 14 in isolation. In the illustrated embodiment, the attachment portion 14 represents one type of attachment mechanism and comprises a toggle clamp 14 that is sized and adapted to fit over and clamp to the faucet-coupling nut of a beer tap 12, a feature that is essentially the same in many different taps. The toggle clamp 14 can be repeatedly opened and closed, meaning that the display 10 as a whole can be easily moved, removed, and replaced from the tap 12 on which it is installed. Of course, as those of skill in the art will realize, any type of attachment mechanism may be used, and the holder and display 10 may be attached to other parts of a tap 12, or to other structures entirely. For example, the clamp can be of a type that is adjustable so as to accommodate potentially different sized beverage taps or the like. Thus, the circumference of the clamp can be adjusted in this alternative embodiment.

The connector 16 extends from the toggle clamp 14 to connect it with the advertisement frame 18. Specifically, the toggle clamp 14 includes a base structure 26 that extends outwardly from it. The connector 16 inserts into an opening 28 in the base structure 26. The opening 28, or the bottom portion of the connector 16, may be surrounded by a ring of a flexible material 30, which may be used for strain relief.

The advertisement frame 18 has an internal channel 22 allowing it to carry the advertisement 20, which, as explained briefly above, may be a piece of card stock with printed advertising indicia 24. The advertisement 20 itself may be made of paper, plastic, or another material. For example, it may be made of card stock. It may be single-sided or double-sided, depending on the area and manner in which it is to be installed, although in many cases, it will be advantageous if the advertisement itself is double-sided. Because the advertisement 20 of the illustrated embodiment is double-sided, the advertisement frame 18 is open to both sides; however, in some embodiments, the advertisement frame 18 may have a backing on one side that obscures the advertisement. Moreover, while the advertisement 20 of the illustrated embodiment is a printed advertisement, in some cases, the frame 18 may accommodate or be a part of an electronic advertisement display.

As installed, the holder and frame 10 extends several inches (e.g., 4-6 inches) from the tap 12 on which it is installed and allows the advertisement 20 to be seen from both sides. The advertisement 20 may advertise a complementary or related product; for example, it may advertise a liquor if the holder and display is attached to a beer tap.

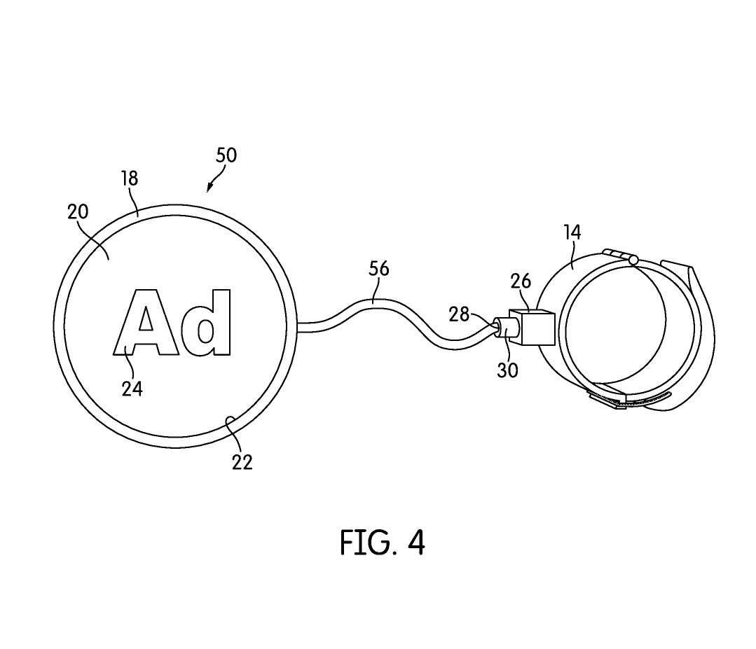

The connector 16 may be rigid, flexible, or resilient depending on the embodiment, and there are advantages to each of these configurations. In the embodiment of FIG. 1, the connector 16 is essentially rigid. However, in another embodiment of an advertising display and holder 50, illustrated in the perspective view of FIG. 4, the connector 56 is flexible, but holds its position once set. As shown, this allows the advertisement frame 18 to be placed in any number of positions relative to the connector 56. In this embodiment, the connector 56 may be a piece of malleable wire, or any other type of flexible shaft that will hold its configuration once positioned. If the connector 56 is a malleable wire, it may be covered, protected, or coated with a layer of paint, fabric, plastic, or any other suitable coating material. For example, it may be covered with vinyl. Coverings may provide the connector 56 with strain relief and help to prevent breakage.

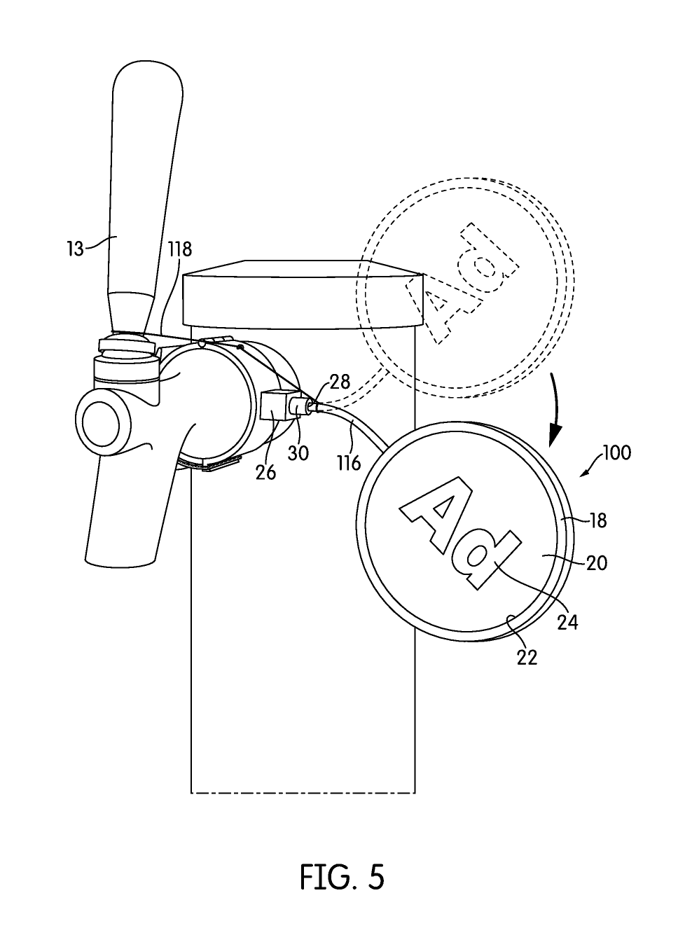

FIG. 5 is a perspective view of another embodiment of an advertisement holder and display 100, shown as installed on a beer tap 12. The advertisement holder and display 100 includes a resilient connector 116. For example, the connector may be a coil spring. This allows for resilient, oscillating movement of the advertisement frame 18, which may attract additional attention. In some embodiments, the advertisement holder and display 100 may be installed on or coupled to a moving object such that movement of the object drives the connector 116 and, in turn, the advertisement frame 18, to move.

As can be seen in FIG. 5, the connector 116 is connected to the tap handle 13 by a flexible, essentially inelastic member 118 so that when the tap handle 13 is actuated, the advertisement frame 18 will move and may oscillate resiliently for some time after the tap handle 13 is released. In the illustrated embodiment, the flexible, essentially inelastic member 118 is a string, although it may be string, chain, cord or any other suitable material in other embodiments. As shown, the string 118 is tied around the connector 116 on one end and around the handle 13 on the other.

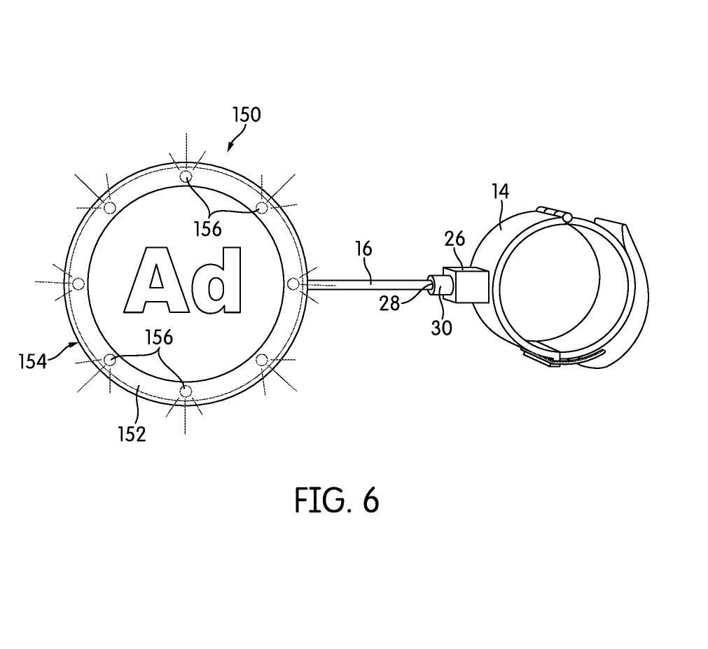

In the above description, the advertisement frame 18 carries only the advertisement 20. However, in some embodiments, the advertisement frame 18 may carry other elements that help to draw attention to the advertisement. For example, as shown in the perspective view of FIG. 6, in one embodiment of the holder 150, the rim 152 of the advertisement frame 154 may carry illuminating elements 156, such as light emitting diodes (LEDs), that illuminate the advertisement.

If the holder and display 150 includes illuminating elements 156, those elements may be activated and powered by a simple circuit that includes a battery and a switch, or by a circuit that activates them at predetermined or random intervals, or activates selected illuminating elements 156 in a particular sequence to create a pattern. In some embodiments, the illumination may be motion-activated, such that, for example, when the tap handle 13 is actuated, the illumination on the advertisement is activated. Motion- or tilt-activated illumination may be achieved by installing an accelerometer, an inclinometer, or another type of small motion-detecting device on the advertisement frame, or on another portion of the holder and display 150 that will be subjected to vibrations or movements.

It should be understood that while the advertisement frame 18, 154 may carry illumination, it is not the only portion of the holder and display 10, 50, 100, 150 that may be adapted to carry illumination or other features that call attention to the advertisement 20. Any portion of the holder and display 10, 50, 100, 150 may carry such features. For example, the connector 16 may carry an LED that is focused on and illuminates the advertisement 20. The power supply and circuit elements to control and power the illumination elements 156, and any other features requiring power and electronic control, may be located anywhere. As one example, a battery or other power supply may be carried by the attachment portion 14 and electrically connected to the lighting elements by appropriate wires (e.g., routed through the connector 16 or external to it). Alternatively, the power elements may be carried within the attachment frame 18, 154 itself, if the frame 18, 154 is large enough.

Although the above description has focused on the use of holders and displays 10, 50, 100, 150 with beverage dispensers, as was described briefly above, holders and displays 10, 50, 100, 150 may be installed on other structures. For example, holders and displays 10, 50, 100, 150 may be installed on urinals.

While the invention has been described with respect to certain embodiments, the embodiments are intended to be illuminating, rather than limiting. Modifications and changes may be made within the scope of the invention, which is defined by the following claims.

What is claimed is:

1. An advertising holder and display comprising:
an attachment mechanism;
an elongate connector with a first end and a second end, the first end of the connector being connected to the attachment mechanism; and
an advertisement frame adapted to hold an advertisement, the advertisement frame being connected to the second end of the connector.

2. The advertising holder and display of claim 1, wherein the attachment mechanism comprises a clamp adapted to fit over a faucet nut.

3. The advertising holder and display of claim 2, wherein the elongate connector is essentially rigid.

4. The advertising holder and display of claim 2, wherein the elongate connector is flexible and user-positionable.

5. The advertising holder and display of claim 2, wherein the elongate connector is resilient.

6. The advertising holder and display of claim 2, further comprising an illumination system positioned and adapted to illuminate an advertisement carried by the advertisement frame.

7. The advertising holder and display of claim 1, wherein the advertisement frame is round and has an interior channel to hold an advertisement.

8. An advertising holder and display, comprising:
a clamp sized, shaped, and adapted to attach to an external surface of a pipe or nut;
an advertisement frame adapted to hold an advertisement; and
a flexible, positionable shaft connected between the clamp and the advertisement frame, the shaft having sufficient rigidity to hold the advertisement frame in a defined position.

9. The advertising holder and display of claim 8, farther comprising an advertisement mounted in the advertisement frame.

10. The advertising holder and display of claim 9, wherein the advertisement is a printed advertisement.

11. The advertising holder and display of claim 8, wherein the advertisement frame is substantially round.

12. The advertising holder and display of claim 8, wherein the advertisement has an interior channel adapted to hold the advertisement.

13. A method of advertising comprising:
installing an advertising holder and display on a beverage tap, the advertising holder and display including:
an attachment mechanism configured to mate with the beverage tap;
an elongate connector with a first end and a second end, the first end of the connector being connected to the attachment mechanism, and
an advertisement frame adapted to hold an advertisement, the advertisement frame being connected to the second end of the connector.

14. The method of claim 13, wherein the beverage tap comprises a beer tap and the installing further comprises installing the attachment mechanism on a faucet nut.

15. The method of claim 14, wherein the attachment mechanism comprises a clamp adapted to be secured around the faucet nut.

16. The method of claim 13, further comprising connecting the connector to an actuatable portion of the beverage tap using a connecting member, such that a movement of the actuatable portion results in a movement of at least the advertisement frame.

17. The method of claim 16, wherein the actuatable portion comprises a faucet or tap handle.

18. The method of claim 16, wherein the connecting member comprises a flexible member connected between the actuatable portion and the connector.

19. A beverage dispenser with an advertisement holder comprising:
a faucet structure and a faucet handle that are part of the beverage dispenser; and
wherein the advertisement holder includes:
a clamp sized, shaped, and adapted to attach to the faucet structure,
an advertisement frame adapted to hold an advertisement, and
a flexible, positionable shaft connected between the clamp and the advertisement frame, the shaft having sufficient rigidity to hold the advertisement frame in a defined position.

20. The beverage dispenser of claim 19, wherein the beverage dispenser is a beer tap.
